(19) United States
(12) Patent Application Publication
(10) Pub. No.: US 2022/0255924 A1
(43) Pub. Date: Aug. 11, 2022

(54) MULTI-FACTOR APPROACH FOR AUTHENTICATION ATTACK DETECTION

(71) Applicant: Cisco Technology, Inc., San Jose, CA (US)

(72) Inventors: Frank Michaud, Pully (CH); Christopher James Pedder, Geneve (CH); David John Zacks, Vancouver (CA); Thomas Szigeti, Vancouver (CA)

(21) Appl. No.: 17/168,322

(22) Filed: Feb. 5, 2021

(51) Int. Cl. H04L 29/06; G06N 7/00

(52) U.S. Cl. CPC H04L 63/0861; G06N 7/005; H04L 63/1433; H04L 63/1416

(57) ABSTRACT

Disclosed are methods, systems, and non-transitory computer-readable media for detecting a presentation attack in a biometric factor domain, such as a multi-factor authentication environment. The methods, systems, and non-transitory computer-readable media comprise analyzing data relevant to a plurality of factors for evaluating whether an authentication attempt by a user is subject to the presentation attack and determining that the authentication attempt is subject to the presentation attack based on analysis of the data from the plurality of factors. The methods, systems, and non-transitory computer-readable media can detect a presentation attack even when the authentication attempt is successful.

The present technology pertains to detecting a presentation attack in a biometric factor domain, and more specifically to using data obtained from multiple identifying factors from a user to determine whether or not the user is subject to a presentation attack.

### SUMMARY

The rise of multi-factor authentication systems has been a boon for device security. Using a plurality of factors, including biometrics, services have been able to increase the certainty with which users are known to operate their devices. However, the proliferation of factors has also enabled the rise of presentation attacks, adversarial attacks wherein a specific factor is successful spoofed and thus is used to gain admission to otherwise protected resources. One presentation attack of particular note involves the spoofing of biometric data, such as facial recognition data, vocal recognition data, fingerprint data, or other data tied directly to the trusted user.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example continuous multi-factor authentication (CMFA) system in accordance with some aspects of the present technology;

FIG. 2 illustrates an example presentation attack detection (PAD) system in accordance with some aspects of the present technology;

FIG. 3 illustrates a detail of an example presentation attack detection (PAD) system in accordance with some aspects of the present technology;

FIGS. 4A and 4B illustrate flowcharts of methods for detecting a presentation attack in a biometric factor domain in accordance with some aspects of the present technology; and

FIG. 5 illustrates an example system for implementing certain aspects of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for the convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control. Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### Overview

Methods, systems, and non-transitory computer-readable media are provided for detecting a presentation attack in a biometric factor domain.

A method can include analyzing data relevant to a plurality of factors for evaluating whether an authentication attempt by a user is subject to the presentation attack and determining that the authentication attempt is subject to the presentation attack based on analysis of the data from the plurality of factors.

In some embodiments of the method, analyzing the data relevant to the plurality of factors includes comparing the data relevant to the plurality of factors to historical data for the plurality of factors.

In some embodiments of the method, the historical data for the plurality of factors is a blend of historical user-specific data and historical population data.

In some embodiments of the method, detecting the presentation attack occurs in a continuous multifactor authentication platform.

In some embodiments, the method further includes determining by the continuous multifactor authentication platform that the user satisfies a set of identification criteria and denying authentication of the user in response to determining that the authentication attempt is subject to the presentation attack.

In some embodiments, determining that the authentication attempt is subject to the presentation attack comprises using a probabilistic Bayesian scoring model on the plurality of factors.

In some embodiments, the method further includes creating a model for scoring authentication attempts as authentic or inauthentic using probabilistic Bayesian scoring wherein the model incorporates sets of training data for the plurality of factors mapped to a classification of known presentation attack or no presentation attack.

In some embodiments, the method further includes repeatedly receiving the data relevant to the plurality of factors.

In some embodiments of the method, analyzing the data relevant to the plurality of factors includes repeatedly evaluating how the plurality of factors has changed over time.

In some embodiments of the method, analyzing the data relevant to the plurality of factors includes inputting the data relevant to the plurality of factors into the model for scoring authentication attempts and receiving a probability that the authentication attempt is subject to the presentation attack.

In some embodiments of the method, determining that the presentation attack is occurring is made when the probability that the authentication attempt is subject to the presentation attack is greater than a threshold, and the method further includes denying access to a user account associated with the authentication attempt that is subject to the presentation attack.

In some embodiments of the method, the plurality of factors includes at least one of camera data, audio data, entropy measurements of background video data, entropy measurements of background audio data, device accelerometer data, device gyroscope data, application behavior, network utilization behavior, connected network device data, connected network device behavior, or advanced malware analysis.

In some embodiments of the method, at least one of the plurality of factors is other than a biometric factor.

A system can include a storage configured to store instructions and a processor configured to execute the instructions and cause the processor to analyze data relevant to a plurality of factors for evaluating whether an authentication attempt by a user is subject to the presentation attack and determine that the authentication attempt is subject to the presentation attack based on analysis of the data from the plurality of factors.

A non-transitory computer-readable medium can include instructions which, when executed by a processor, cause the processor to analyze data relevant to a plurality of factors for evaluating whether an authentication attempt by a user is subject to the presentation attack and determine that the authentication attempt is subject to the presentation attack based on analysis of the data from the plurality of factors.

### Description of Example Embodiments

Presentation attacks are authentication attempts made by adversaries posing as trusted users. As multi-factor authentication systems have proliferated, the sophistication of such attacks has increased, making them harder to detect. For example, multi-factor authentication systems can use facial recognition to affirm the identity of a user. Adversaries can use 2-dimensional or 3-dimensional masks to impersonate the trusted user, thus spoofing the identity of the user and attaining access to a protected resource.

Correctly identifying presentation attacks and denying such attackers access to resources presents an important problem for security and privacy of device users. The present technology provides a solution to this problem for presentation attacks focused on spoofing biometric factors of a trusted user. Notably, the present technology can detect presentation attacks even when the presentation attack is sufficiently sophisticated to fool the authentication process.

This disclosure will first discuss an example continuous multi-factor authentication (CMFA) system. Then, the disclosure will discuss example embodiments related to detecting a presentation attack in a biometric factor domain. Finally, the disclosure will discuss an example computing system which can be used to execute the present technology.

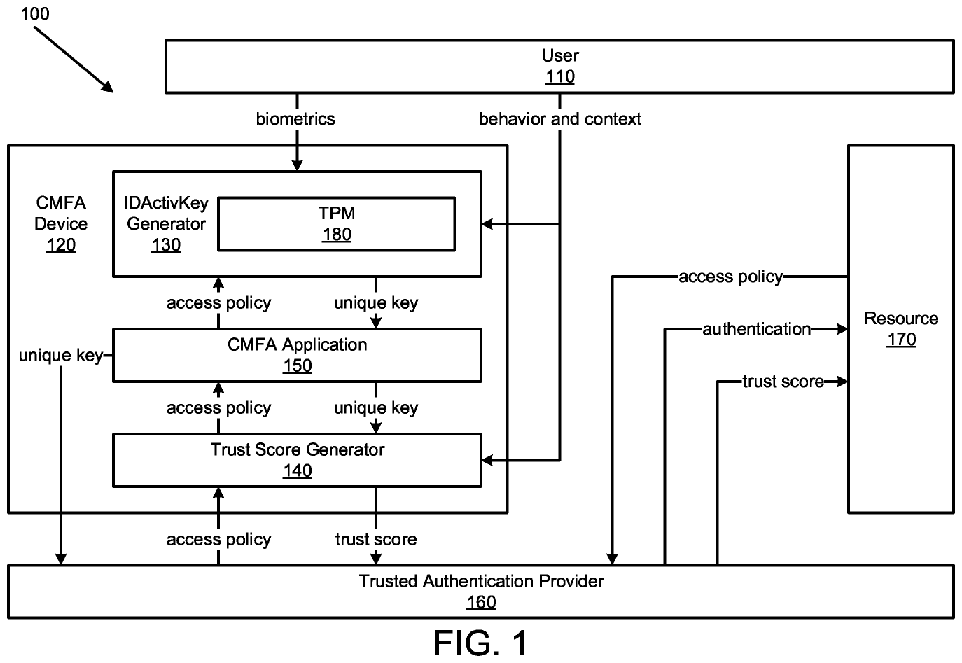

FIG. 1 illustrates an example continuous multi-factor authentication (CMFA) system 100 in accordance with some aspects of the present technology. User 120 can gain authorized access to resource 170 by using CMFA device 120.

Resource 170 can be any service, resource, device, or entity which requires authentication of user 110. For example, resource 170 can be a social media service, bank, hospital, motor vehicle department, bar, voting system, Internet of Things (TOT) device, or access device. In some embodiments, resource 170 can be accessed by user 110 through an access device, such as a mobile phone or personal computer. In some embodiments, resource 170 can be accessed by user 110 through an application that is specifically designed for accessing resource 170, or through a more general application which can access multiple services, such as a web browser, or portions of an operating system. In some embodiments, resource 170 can be the same device as CMFA device 120. In some embodiments, resource 170 can be a plurality of resources, such as an access device and a service which receive separate authentications from trusted authentication provider 160.

Resource 170 can authenticate the identity of user 110 through trusted authentication provider 160, which can be in communication with CMFA device 120. Data gathered by CMFA device 120 can be used for authentication of user 110 to resource 170 via trusted authentication provider 160. Trusted authentication provider 160 can receive an identification credential, such as an IDActivKey, from CMFA device 120 via CMFA application 150 that is unique to resource 170 for user 110. Trusted authentication provider 160 can also receive a trust score from CMFA device 120 via trust score generator 140. Upon receiving an IDActivKey and a trust score, trusted authentication provider 160 can use this information in tandem with access requirements received from resource 170 to authenticate user 110 to resource 170.

To generate identification credentials, CMFA Device 120 can be associated with user 110 and can gather biometric, behavioral, and contextual data from user 110. The biometric, behavioral, or contextual data, or some combination thereof, can be used by IDActivKey generator 130 to generate a unique IDActivKey corresponding to resource 170. These biometrics can include, for example, fingerprints, facial detection, retinal scans, voice identification, or gait data, among other biometrics. For each resource 170, a cryptographic seed from a pseudo-arbitrary number generator in trusted platform module (TPM) 180 can be used to select a sampling of the biometric data to be used in an IDActivKey for the application in question. In some embodiments, the IDActivKey may only be derived when CMFA device 120 determines that certain behavioral and contextual requirements indicate compliance with a policy. In some embodiments, there can be a “master” IDActivKey that is used to gain access to trusted authentication provider 160.

In some embodiments, behavioral and contextual data can be used to ensure that the context of user 110 is acceptable as specified by a policy of resource 170. Behavioral and contextual data can be used by trust score generator 140, which can generate a trust score as a measure of confidence in the authentication of user 110, and as a measure of confidence that the authenticated user 110 is still present and behaving acceptably as specified by a policy of resource 170.

In some embodiments, trusted computing implementations, such as TPM 180, can rely on roots of trust. Roots of trust can provide assurances that the root has been implemented in a way that renders it trustworthy. A certificate can identify the manufacturer and evaluated assurance level (EAL) of TPM 180. Such certification can provide a level of confidence in the roots of trust used in TPM 180. Moreover, a certificate from a platform manufacturer may provide assurance that TPM 180 was properly installed on a system that is compliant with specific requirements so the root of trust provided by the platform may be trusted. Some implementations can rely on three roots of trust in a trusted platform, including roots of trust for measurement (RTM), storage (RTS), and reporting (RTR).

Trust score generator 140 can generate a trust score for user 110 using behavioral and contextual data, the surrounding environment, or other sources. For example, location information can be derived from the network that user 110 is using. These data can include information about location, movement, or device behavior. The trust score reflects a confidence level that user 110 complies with a policy specified by resource 170. This includes the confidence that user 110 is the person operating the current session.

Trusted authentication provider 160 can request updated IDActivKeys and trust scores at different intervals depending on the requirements specified by the access policies defined by resource 170. It can send new access policies received from resource 170 during a session to CMFA device 120. Trusted authentication provider 160 can shield private information from resource 170, providing authentication without revealing personal information such as birth dates, social security numbers, or marital status, etc. In some embodiments, trusted authentication provider 160 need only inform resource 170 that access should be granted, while in some embodiments trusted authentication provider 160 can send an IDActivKey to resource 170.

User 110 can be any user including an employee, contractor, client, member of an organization, or private individual, etc. attempting to access a service. User 110 can use an access device to access resource 170 which may or may not be the same device as CMFA device 120. In some embodiments, CMFA device 120 can be used to authenticate an access device.

CMFA device 120 can be hardware, software-only, or combinations thereof. CMFA device 120 can be a mobile device or a personal computer; it may or may not be the same device as access device. In some embodiments, CMFA device 120 can include secure hardware such as TPM 180. In some embodiments, one or more of IDActivKey generator 130, TPM 180, and trust score generator 140 can be located in a physically separate and secure portion of CMFA device 120.

While FIG. 1 only illustrates one application 190, and one resource 170, it should be appreciated that there can be any number of applications 190 or application providers 170. Each resource 170 can have an access policy, and any IDActivKey will be unique to each respective resource 170.

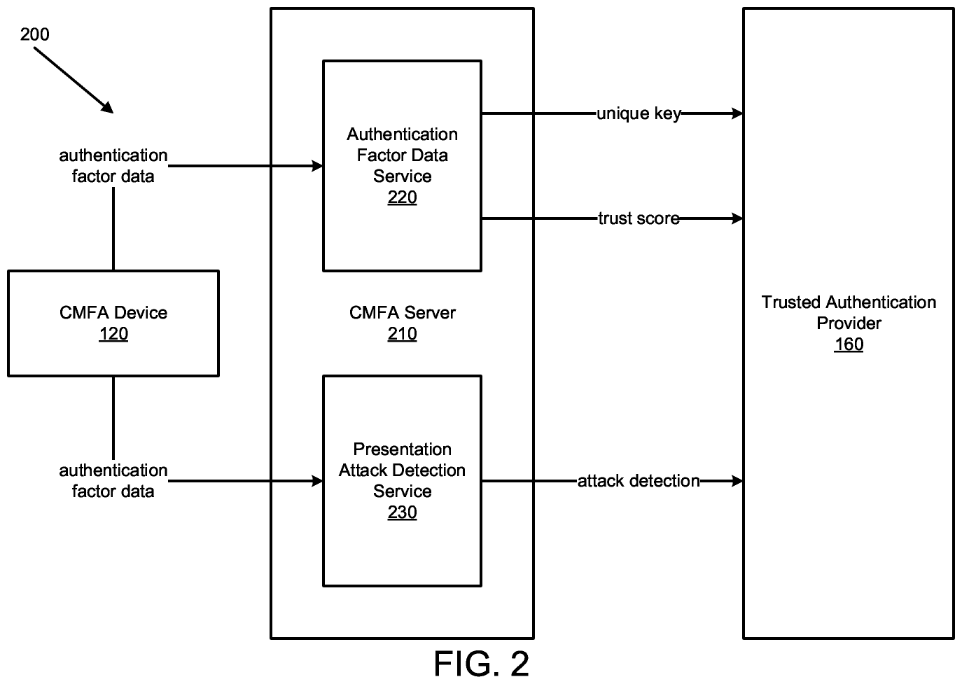

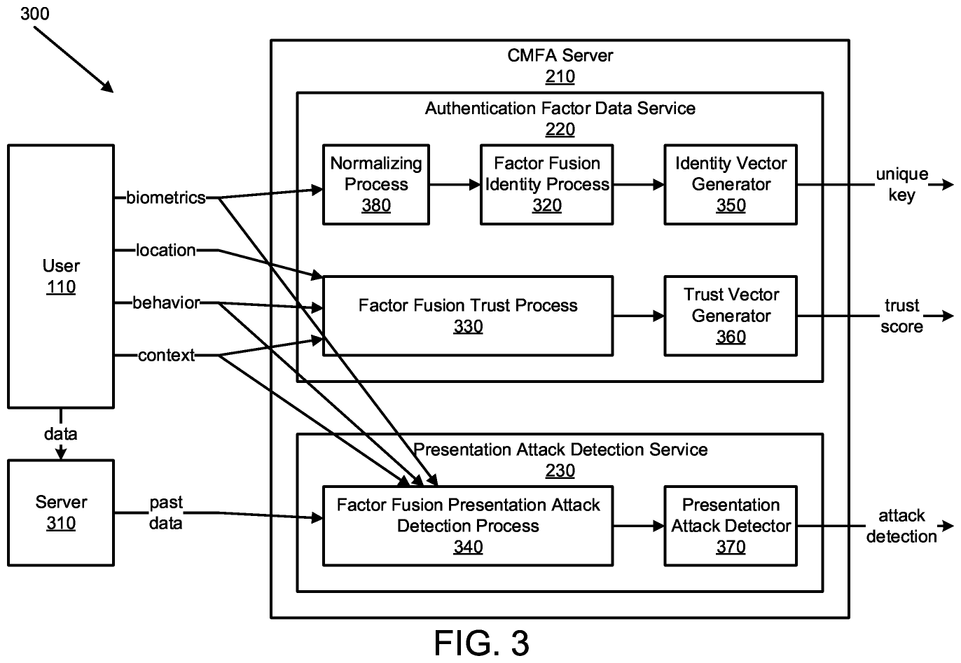

The system described in FIG. 1 is potentially vulnerable to presentation attacks. An adversary pretending to be user 110 could leverage factors used in generating the unique key and trust score to gain access to resource 170. FIGS. 2 and 3 illustrate systems which aim to mitigate and ultimately prevent such attacks.

FIG. 2 illustrates an example presentation attack detection (PAD) system 200 in accordance with some aspects of the present technology. CMFA server 210 can process authentication factor data, including biometric factor data, to detect a presentation attack.

CMFA server 210 can receive authentication factor data from CMFA device 120. This authentication factor data can comprise biometric data, behavioral data, contextual data, or other factor data gathered from user 110. Biometric data can include facial recognition data, vocal recognition data, fingerprint data, gait data, or other factors. Generally, authentication data factors can include camera data, audio data, entropy measurements of background video data, entropy measurements of background audio data, device accelerometer data, device gyroscope data, application behavior, network utilization behavior, or advanced malware analysis. In some embodiments, at least one of the authentication data factors can be other than a biometric factor. In some embodiments, it can repeatedly or continuously receive the authentication factor data.

CMFA server 210 can analyze the authentication factor data and determine whether an authentication attempt via CMFA device 120 is subject to a presentation attack. Presentation attack detection service 230 can use authentication factor data to determine whether or not the authentication attempt is subject to a presentation attack. Authentication factor data service 220 can analyze authentication factor data to affirm or generate authentication credentials, such as a unique key like the IDActivKey discussed in FIG. 1 or a trust score as discussed in FIG. 1.

Trusted authentication provider 160 can receive the authentication credentials and the attack detection from CMFA server 210. Even when the authentication credentials satisfy identification criteria for user 110, trusted authentication provider 160 can still deny authentication by determining that the authentication attempt is subject to a presentation attack.

In some embodiments, the processes performed by CMFA server 210 can be performed by components of CMFA device 120.

FIG. 3 illustrates a detail 300 of the example presentation attack detection (PAD) system 200, as illustrated in FIG. 2, in accordance with some aspects of the present technology. CMFA server 210 can generate authentication credentials, including a unique key and trust score, as well as detect presentation attacks.

User 110 can generate biometric, behavioral, and contextual data for consumption by CMFA server 210. In addition, user 110 can send its data to server 310, which can store past information about user 110, including prior biometrics, behavior, and context. From this store of past data, server 310 can offer past data for consumption by CMFA server 210.

To generate a unique key, such as an IDActivKey as described in FIG. 1, user 110 can send biometrics to authentication factor data service 220. Normalizing process 380 can normalize biometric data, which is then received by factor fusion identity process 320, which can perform factor fusion and smart combination on the normalized biometric data. From this fused data, identity vector generator 350 can generate the unique key to identify user 110.

To generate a trust score, such as the trust score described in FIG. 1, user 110 can send behavioral and contextual data to authentication factor data service 220. Factor fusion trust process 330 can perform factor fusion and smart combination on the behavioral and contextual data. From this fused data, trust vector generator 360 can generate a trust score for user 110.

To detect a presentation attack, user 110 can send biometric, behavioral, and contextual data to presentation attack detection service 230. The biometric, behavioral, and contextual data can be the same data that is sent to authentication factor data service 220. Attack detection process 230 can also receive past data from server 310. The past data can include both past data from user 110 as well as population-level data. Factor fusion presentation attack detection process 340 can perform factor fusion and smart combination on the received data and forward this data to presentation attack detector 370.

Presentation attack detector 370 can use data received from factor fusion presentation attack detection process 340 to detect presentation attacks by analyzing the received data. In some embodiments, presentation attack detector can analyze the data from user 110 by comparing it to the data from server 310.

In some embodiments, presentation attack detector can create a probabilistic Bayesian scoring model by training it on the past data and use this model to classify the present authentication attempt as a known presentation attack or no presentation attack. In some embodiments, the model can be used to output a probability that the authentication attempt is subject to a presentation attack. In some embodiments, the determination of whether or not the authentication attempt is subject to a presentation attack is based on whether the output probability is greater than a given threshold, and subsequently denying authentication when the probability is greater than the threshold. Support vector machines or Gaussian mixture models can also be used to detect presentation attacks in presentation attack detector 370.

In some embodiments, analysis of the data by presentation attack detector 370 can include repeatedly or continuously evaluating how the incoming data changes over time, especially as it relates to the past data received from server 310.

Even though the same data might be provided to the authentication factor data service 220 and the presentation attack detection service 230, this data might be sufficient to authenticate the user as well as be classified as a presentation attack. This is due to the specific aspects for which each process is tuned.

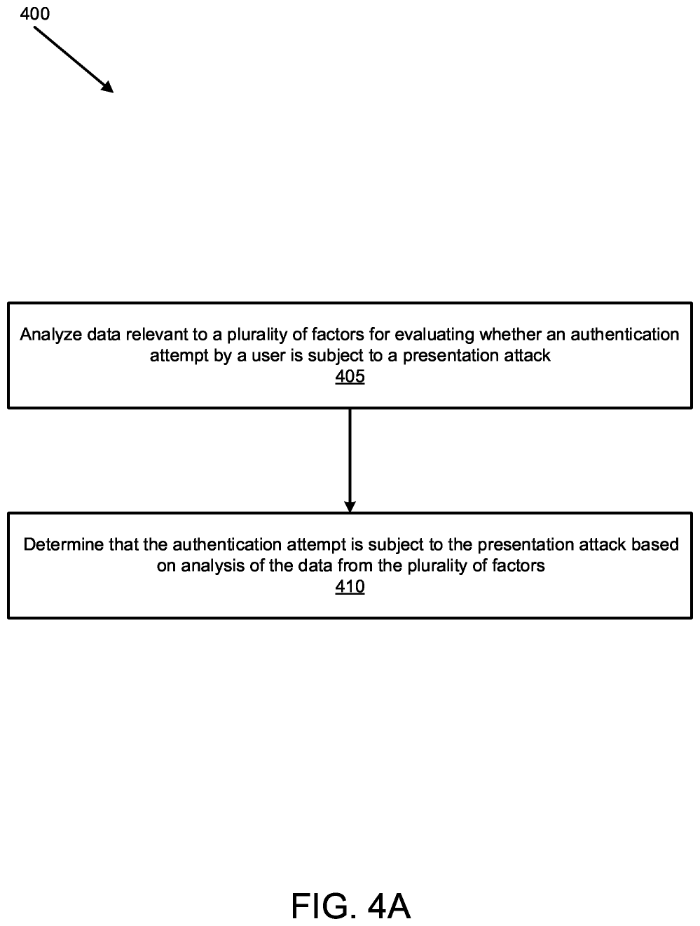

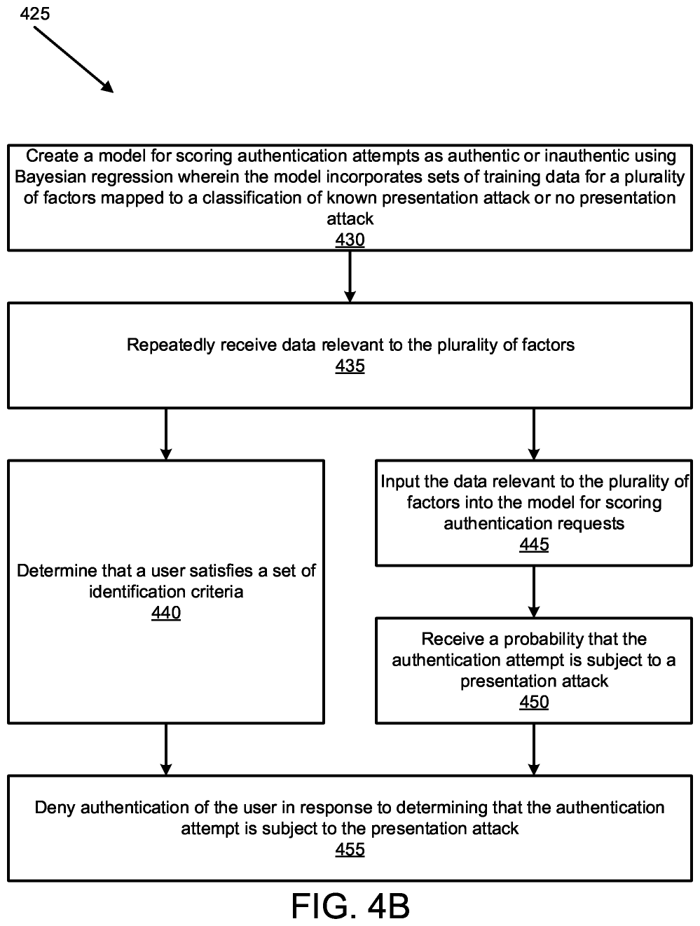

FIG. 4A illustrates an example method 400 detecting a presentation attack in a biometric factor domain. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method includes analyzing data relevant to a plurality of factors for evaluating whether an authentication attempt by a user is subject to the presentation attack at block 405. For example, CMFA device 120 illustrated in FIG. 1 can analyze data relevant to a plurality of factors to evaluate whether an authentication attempt by a user is subject to the presentation attack. In some embodiments, at least some of the data relevant to the plurality of factors can be repeatedly received to provide additional data to analyze. Analyzing the data relevant to the plurality of factors can include comparing the data relevant to the plurality of factors to historical data for the plurality of factors. The historical data for the plurality of factors can be a blend of historical user-specific data and historical population data. Analyzing the data relevant to the plurality of factors can include repeatedly evaluating how the plurality of factors has changed over time. The plurality of factors can include at least one of camera data, audio data, entropy measurements of background video data, entropy measurements of background audio data, device accelerometer data, device gyroscope data, application behavior, network utilization behavior, connected network device data, connected network device behavior, or advanced malware analysis. At least one of the plurality of factors can be other than a biometric factor.

In one embodiment of analyzing data at block 405, the method comprises creating a model for scoring authentication attempts as authentic or inauthentic using probabilistic Bayesian scoring. For example, the CMFA device 120 illustrated in FIG. 1 can create a model for scoring authentication attempts as authentic or inauthentic using probabilistic Bayesian scoring. The model can incorporate sets of training data for the plurality of factors mapped to a classification of known presentation attack or no presentation attack. Further, the method can include inputting the data relevant to the plurality of factors into the model for scoring authentication attempts. Further, the method can include receiving a probability that the authentication attempt is subject to the presentation attack.

Probabilistic Bayesian scoring is a particularly useful model for scoring authentication attempts when there is insufficient data to generate reasonably confident estimates of regression coefficients from the available data alone. The use of Bayesian inference allows the model to use a prior probability distribution to constrain the ultimate estimates of the regression coefficients and errors. In conditions with sufficient data, traditional regression models can be used. In general contexts, models used to score authentication attempts can be machine learning models, neural networks, or any number of other models.

In another embodiment of analyzing data at block 405, the method comprises repeatedly receiving the data relevant to the plurality of factors. For example, the CMFA device 120 illustrated in FIG. 1 can repeatedly receive the data relevant to the plurality of factors.

According to some examples, the method includes determining that the authentication attempt is subject to the presentation attack based on analysis of the data from the plurality of factors at block 410. For example, CMFA device 120 illustrated in FIG. 1 can determine that the authentication attempt is subject to the presentation attack based on analysis of the data from the plurality of factors. Detecting the presentation attack can occur in a continuous multifactor authentication platform. Determining that the authentication attempt is subject to the presentation attack can include using a probabilistic Bayesian scoring model on the plurality of factors.

In one embodiment of determining that the authentication attempt is subject to the presentation attack at block 410, the method comprises determining, by a continuous multifactor authentication platform, that the user satisfies a set of identification criteria. For example, CMFA device 120 illustrated in FIG. 1 can determine by the continuous multifactor authentication platform that the user satisfies a set of identification criteria. Further, the method comprises denying authentication of the user in response to determining that the authentication attempt is subject to the presentation attack.

In another embodiment of determining that the authentication attempt is subject to the presentation attack at block 410, the method comprises denying access to a user account associated with the authentication attempt that is subject to the presentation attack. This can occur even though the user has presented themselves sufficiently to be authenticated based on one or more biometric factors. For example, CMFA device 120 illustrated in FIG. 1 can deny access to a user account associated with the authentication attempt that is subject to the presentation attack. Determining that the presentation attack is occurring can be made when the probability that the authentication attempt is subject to the presentation attack is greater than a threshold.

FIG. 4B illustrates an example method 425 detecting a presentation attack in a biometric factor domain. Although the example method 425 depicts a particular sequence of operations, the sequence may be altered without departing from the scope of the present disclosure. For example, some of the operations depicted may be performed in parallel or in a different sequence that does not materially affect the function of the method 425. In other examples, different components of an example device or system that implements the method 425 may perform functions at substantially the same time or in a specific sequence.

According to some examples, the method includes creating a model for scoring authentication attempts as authentic or inauthentic using probabilistic Bayesian scoring wherein the model incorporates sets of training data for the plurality of factors mapped to a classification of known presentation attack or no presentation attack at block 430. For example, CMFA device 120 illustrated in FIG. 1 can create a model for scoring authentication attempts as authentic or inauthentic using probabilistic Bayesian scoring wherein the model incorporates sets of training data for the plurality of factors mapped to a classification of known presentation attack or no presentation attack.

According to some examples, the method includes repeatedly receiving data relevant to the plurality of factors at block 435. For example, CMFA device 120 illustrated in FIG. 1 can repeatedly receive data relevant to the plurality of factors.

According to some examples, the method includes determining that a user satisfies a set of identification criteria at block 440. For example, CMFA device 120 illustrated in FIG. 1 can determine that a user satisfies a set of identification criteria that is sufficient to authenticate a user, if not for the presentation attack detection addressed herein.

According to some examples, the method includes inputting the data relevant to the plurality of factors into the model for scoring authentication attempts at block 445. For example, CMFA device 120 illustrated in FIG. 1 can input the data relevant to the plurality of factors into the model for scoring authentication attempts.

According to some examples, the method includes receiving a probability that the authentication attempt is subject to a presentation attack at block 450. For example, CMFA device 120 illustrated in FIG. 1 can receive a probability that the authentication attempt is subject to a presentation attack.

According to some examples, the method including denying authentication of the user in response to determining that the authentication attempt is subject to the presentation attack at block 455. For example, CMFA device 120 illustrated in FIG. 1 can deny authentication of the user in response to determining that the authentication attempt is subject to the presentation attack at block 455. Determining that the authentication attempt is subject to the presentation attack can include determining that the probability that the authentication attempt is subject to the presentation attack is greater than a threshold.

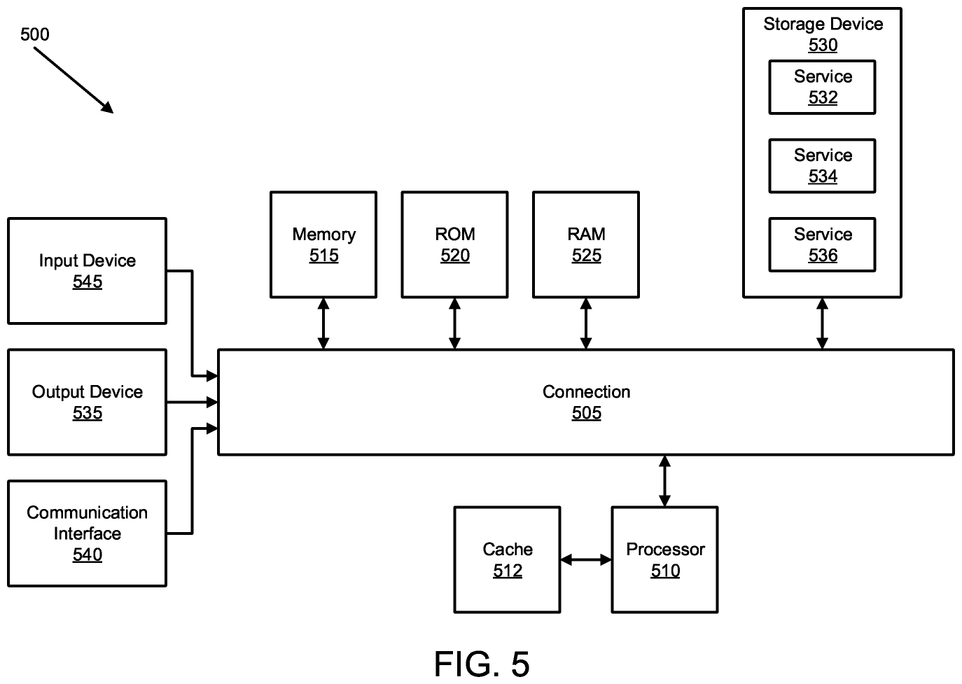

FIG. 5 shows an example of computing system 500, which can be for example any computing device making up CMFA server 210, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random access memory (RAM) 525 to processor 510. Computing system 500 can include a cache of high-speed memory 512 connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A method for detecting a presentation attack in a biometric factor domain comprising:
analyzing data relevant to a plurality of factors for evaluating whether an authentication attempt by a user is subject to the presentation attack; and
determining that the authentication attempt is subject to the presentation attack based on analysis of the data from the plurality of factors.

2. The method of claim 1, wherein analyzing the data relevant to the plurality of factors includes comparing the data relevant to the plurality of factors to historical data for the plurality of factors.

3. The method of claim 2, wherein the historical data for the plurality of factors is a blend of historical user-specific data and historical population data.

4. The method of claim 1, wherein detecting the presentation attack occurs in a continuous multifactor authentication platform.

5. The method of claim 4, further comprising:
determining by the continuous multifactor authentication platform that the user satisfies a set of identification criteria; and
denying authentication of the user in response to determining that the authentication attempt is subject to the presentation attack.

6. The method of claim 1, wherein determining that the authentication attempt is subject to the presentation attack comprises using a probabilistic Bayesian scoring model on the plurality of factors.

7. The method of claim 1, further comprising:
creating a model for scoring authentication attempts as authentic or inauthentic using probabilistic Bayesian scoring wherein the model incorporates sets of training data for the plurality of factors mapped to a classification of known presentation attack or no presentation attack.

8. The method of claim 1, further comprising:
repeatedly receiving the data relevant to the plurality of factors.

9. The method of claim 1, wherein analyzing the data relevant to the plurality of factors includes repeatedly evaluating how the plurality of factors has changed over time.

10. The method of claim 7, wherein analyzing the data relevant to the plurality of factors comprises:
inputting the data relevant to the plurality of factors into the model for scoring authentication attempts; and
receiving a probability that the authentication attempt is subject to the presentation attack.

11. The method of claim 10, wherein determining that the presentation attack is occurring is made when the probability that the authentication attempt is subject to the presentation attack is greater than a threshold, the method further comprising:
denying access to a user account associated with the authentication attempt that is subject to the presentation attack.

12. The method of claim 1, wherein the plurality of factors includes at least one of camera data, audio data, entropy measurements of background video data, entropy measurements of background audio data, device accelerometer data, device gyroscope data, application behavior, network utilization behavior, connected network device data, connected network device behavior, or advanced malware analysis.

13. The method of claim 1, wherein at least one of the plurality of factors is other than a biometric factor.

14. A system for detecting a presentation attack in a biometric factor domain comprising:
a storage configured to store instructions; and
a processor configured to execute the instructions and cause the processor to:
analyze data relevant to a plurality of factors for evaluating whether an authentication attempt by a user is subject to the presentation attack; and
determine that the authentication attempt is subject to the presentation attack based on analysis of the data from the plurality of factors.

15. The system of claim 14, wherein detecting the presentation attack occurs in a continuous multifactor authentication platform, and wherein the instructions further cause the processor to:
determine by the continuous multifactor authentication platform that the user satisfies a set of identification criteria; and
deny authentication of the user in response to determining that the authentication attempt is subject to the presentation attack.

16. The system of claim 14, wherein the instructions further cause the processor to:
create a model for scoring authentication attempts as authentic or inauthentic using probabilistic Bayesian scoring wherein the model incorporates sets of training data for the plurality of factors mapped to a classification of known presentation attack or no presentation attack.

17. The system of claim 14, wherein the instructions further cause the processor to:
repeatedly receive the data relevant to the plurality of factors.

18. The system of claim 16, wherein the instructions for analyzing the data relevant to the plurality of factors cause the processor to:
input the data relevant to the plurality of factors into the model for scoring authentication attempts; and
receive a probability that the authentication attempt is subject to the presentation attack.

19. The system of claim 18, wherein determining that the presentation attack is occurring is made when the probability that the authentication attempt is subject to the presentation attack is greater than a threshold, wherein the instructions further cause the processor to:
deny access to a user account associated with the authentication attempt that is subject to the presentation attack.

20. A non-transitory computer-readable medium containing therein instructions which, when executed by a processor, cause the processor to detect a presentation attack in a biometric factor domain, the instructions effective to cause the processor to:
analyze data relevant to a plurality of factors for evaluating whether an authentication attempt by a user is subject to the presentation attack; and
determine that the authentication attempt is subject to the presentation attack based on analysis of the data from the plurality of factors.
